(19) United States
(12) Patent Application Publication
(10) Pub. No.: US 2007/0019239 A1
(43) Pub. Date: Jan. 25, 2007

(54) METHOD OF GENERATING A COLOR HALFTONE SCREEN AND A SYSTEM THEREOF

(76) Inventors: Hae-kee LEE, Suwon-si (KR); Goo-soo GAHANG, Yongin-si (KR); Byong-min KANG, Incheon (KR); Choon-woo KIM, Seoul (KR)

Correspondence Address: STANZIONE & KIM, LLP, 919 18TH STREET, N.W., SUITE 440, WASHINGTON, DC, 20006, US

(21) Appl. No.: 11/277,567

(22) Filed: Mar. 27, 2006

(30) Foreign Application Priority Data
Jul. 25, 2005 (KR) 2005-67570

(51) Int. Cl. H04N 1/405

(52) U.S. Cl. 358/3.06

(57) ABSTRACT

A color halftone screen generating method and a system thereof. The color halftone screen generating method includes determining a dot center of each of a plurality of channels arbitrarily, selecting a predetermined number of applicants in a sequence in which cost values are small for each channel by performing a mask operation for each channel, overlapping the determined dot centers of the channels and computing an overlap cost value using an overlap filter, and output selecting an applicant closest to a position having a minimum overlap cost value among overlap cost values of the applicants. The color halftone screen generating method and system can reduce a pattern of low frequency characteristics generated due to overlapping of color channels and improve quality of a binary output image by uniformly distributing overlapped cluster dots.

### CROSS-REFERENCE TO RELATED APPLICATIONS

This application claims the benefit under 35 U.S.C. § 119 (a) of Korean Patent Application No. 2005-67570 filed on Jul. 25, 2005 in the Korean Intellectual Property Office, the disclosure of which is incorporated herein by reference in its entirety.

### BACKGROUND OF THE INVENTION

1. Field of the Invention

The present general inventive concept relates to a method of generating a color halftone screen in an image forming device and a system thereof, and more particularly, to a method of generating a color halftone screen to improve color printing quality in an image forming device, and a system thereof.

2. Description of the Related Art

Generally, printing devices have two binary levels (black-1 and white-0) according to whether dots are printed. This is different from multi-level image devices that can print a variety of levels. A method of printing a multi-level input image in a binary level is called “a halftoning method.”

In other words, an image having 256 brightness scales from 0 to 255 is generally called “a continuous gray-level image,” and the halftoning method expresses the continuous gray-level image in a binary output device having only the two binary levels 0 (i.e., black) and 255 (i.e., white). An image generated using the halftoning method is referred to as “a binary image.”

The halftoning method is largely divided into screening, error spreading, and halftoning through optimization. Among these three, the screening is a method that performs binarization by comparing a gray-level value of a pixel to be binarized with a predetermined screen, which is a threshold array, while the error spreading is a method that takes an error caused by the binarization into consideration by performing spreading on surrounding pixels to be binarized based on a predetermined kernel value at a predetermined rate.

The screening is faster than the error spreading, but the screening has an inferior image quality at a low definition level. Since the error spreading is not suitable for a laser printing device with irregular dot positions and sizes, the screening is widely used in laser printing devices.

Screens are divided into an amplitude modulated (AM) screen and a frequency modulated (FM) screen according to how dots are arrayed. Since the AM screen outputs clusters of dots, the AM screen can output dots more stably than the FM screen.

For this reason, most laser printing devices use the AM screen. The AM screens are divided into an AM ordered screen and an AM stochastic screen according to the manner in which the clustered dots are arrayed.

An output image that is binarized by using the AM ordered screen has a periodic cluster dot array or a periodic halftone dot array. However, an output image that is binarized by using the AM stochastic screen does not have a periodic cluster dot array.

The AM ordered screen may have an unpleasant pattern due to the periodic cluster dot pattern. Particularly, when an input image has a periodic pattern, the output image has a subject moiré pattern having a periodic band in a predetermined direction.

In an attempt to solve the above problems, a conventional method of generating a screen that does not have a periodic cluster dot array has been used. The conventional screen-generating method forms clusters out of halftone dots by changing a spatial filter (i.e., an evaluation function).

FIG. 1 illustrates a conventional AM stochastic screen generating method. Generally, an AM stochastic screen can be generated using two methods which are illustrated in FIG. 1. A first conventional method is a direct dot growing method 10 using a spatial filter in an initial dot and a second conventional method is a swapping growing method 20 using an initial binary pattern.

First, the direct dot growing method 10 will be described. One arbitrary dot is selected as the initial dot and then a continuous dot order is determined based on the spatial filter. A multi-level input expresses an output tone level based on a number of dots, for example, a light gray-level range has a small number of dots while a shadow range has a large number of dots. Herein, the number of dots increases as it goes from a light gray-level to a dark gray-level. The increase in the number of dots is called “growing,” and the gradual increase in the number of dots is called “order.” Herein, the order is determined in a position having a minimum value after performing a mask operation using the spatial filter.

FIG. 2 illustrates a conventional dot order determining method. FIG. 2 illustrates a dot distribution 30 with a predetermined order of 0 to 14. A next order is a fifteenth order 11, and a dot distribution 50 from 0 to 15 is confirmed by determining the fifteenth order 11 in a position ‘A’ on the dot distribution 50 having a minimum value by performing a convolution on the dot distribution 30 having the predetermined order of 0 to 14 using a spatial filter 40. In this manner, the 1 to 15 dot distributions are determined.

The following Equation 1 represents the dot order determining method illustrated in FIG. 2.
cos t(i, j)=filter(i, j)**dot(i, j) Equation 1
where filter (i, j) represents the spatial filter (e.g., the spatial filter 40 in FIG. 2), dot(i,j) represents a dot distribution 50 (e.g., the dot distribution 30 in FIG. 2), and ** represents a circular convolution operation.

Dots having a determined order have a ‘1 (on)’ value, whereas dots not having a determined order have a ‘0 (off)’ value. The mask operation using the spatial filter is performed until all dots have a ‘1’ value. In short, when horizontal and vertical sizes of a screen are M and N, respectively, the dot order has a value from ‘0’ to ‘M*N−1’. The following Equation 2 expresses the above-described spatial filter.

$$filter ( i , j ) = {ⅇ}^{- \frac{{ⅈ}^{2} + {j}^{2}}{2 {σ}_{1}^{2}}} - {ⅇ}^{- \frac{{ⅈ}^{2} + {j}^{2}}{2 {σ}_{2}^{2}}} \qquad Equation 2$$

The Equation 2 uses a difference between two Gaussian functions and, herein, ‘σ₁’ should be always larger than ‘σ₂.’ However, the direct dot growing method has a shortcoming in that the dot distribution is not uniform in a highlight range. For this reason, in most AM stochastic screen generating methods, the mask operation is carried out after the swapping growing method 20 illustrated in FIG. 1 using the initial binary pattern.

In this case, after a predetermined number of dots that can express a particular gray level in an initial period are distributed arbitrarily, the dot distribution is rearrayed by using the spatial filter. A rearray operation method is as follows.

First, a first cost (i.e., cost value from a cost function) for a dot distribution prior to the rearray is calculated and the dot distribution is rearrayed. Then, a second cost for the dot distribution after the rearray is calculated. Among the two costs, the dot distribution with a smaller cost is stored. The above-described process is repeated until the cost converges to a predetermined value. Subsequently, a final dot distribution is defined as a uniform binary pattern. The method of rearraying the dots is called a “swapping operation,” and the numbers of dots before and after the swapping operation should be the same.

When the uniform binary pattern is completed at the particular gray level, the mask operation is performed by using the same spatial filter. For a range lighter than the particular gray level dots are removed one by one and, and for a range darker than the predetermined level dots are added one by one. In an image that is binarized using the AM screen, an undesirable circular pattern disappears when an AM stochastic screen is used, compared to when an AM ordered screen is used.

However, the above-described conventional methods and technologies are only applicable to a one-channel screen, and are not applicable to a multi-channel screen (i.e., a color channel screen (CMYK)). When the multi-channel screen is generated independently (i.e., for each channel color) using the conventional methods and technologies, there is a problem in that a stochastic moiré pattern, which is an interference pattern between channels, is generated.

### SUMMARY OF THE INVENTION

The present general inventive concept provides a method of generating a color halftone screen using correlation(s) between channels to remove a stochastic moiré pattern caused when a halftone screen is generated for a multi-channel environment.

Additional aspects of the present general inventive concept will be set forth in part in the description which follows and, in part, will be obvious from the description, or may be learned by practice of the general inventive concept.

The foregoing and/or other aspects of the present general inventive concept may be achieved by providing a method of generating a color halftone screen in an image forming device, the method including determining a dot center for each of a plurality of channels arbitrarily, selecting a predetermined number of applicants having minimum cost values for each channel by performing a mask operation for each channel, overlapping the determined dot centers of the channels and computing an overlap cost value using an overlap filter, and output selecting an applicant closest to a position having the minimum overlap cost value among overlap cost values from among the applicants.

The mask operation may be performed independently by using a spatial filter with respect to each channel.

The predetermined number of applicants may comprise four applicant dots.

The overlapping of the determined dot centers of the channels comprises overlapping luminance values of the channels.

The channels may include a cyan channel C, a magenta channel M, a yellow channel Y, and a black channel K.

The output selected applicant may be determined as the dot center of the corresponding channel, and the overlapping and output selecting operations may be repeated for the other channels.

The overlapping and output selecting operations may be performed repeatedly until all dots of a screen are selected as the dot center with respect to each channel.

The foregoing and/or other aspects of the present general inventive concept may also be achieved by providing a method of determining dots for a plurality of color channels on a screen, the method comprising selecting a predetermined number of applicant dots associated with initial dot centers for the plurality of color channels, applying an overlap spatial filter to each of the initial dot centers to account for correlations between the color channels and to determine an applicant dot having a minimum cost overlap value with respect to the initial dot centers of each of the color channels, and setting the applicant dots having the minimum cost overlap values with respect to the initial dot centers as new dot centers.

The foregoing and/or other aspects of the present general inventive concept are achieved by providing a system of generating a color halftone screen in an image forming device, including a mask operation unit to perform a mask operation with respect to each of a plurality of channels from a dot center arbitrarily determined for each channel, an applicant selection unit to select a predetermined number of applicants having minimum cost values with respect to each channel based on a result of the mask operation, an overlap unit to overlap the determined dot centers of the channels to produce an overlap result, an overlap cost computation unit to compute an overlap cost value using an overlap filter based on the overlap result, and an output applicant selection unit to select an applicant closest to a position having a minimum overlap cost value among overlap costs of the applicants.

The foregoing and/or other aspects of the present general inventive concept may also be achieved by providing a system to generate a color halftone screen having a plurality of color channels in an image forming device, the system comprising an applicant selection unit to apply a first cost function individually to each existing dot center of the respective color channels on a screen to select a predetermined number of existing dots having minimum cost values with respect to each existing dot center for each color channel, an overlapping unit to overlap the existing dot centers of the respective color channels and to apply a second cost function to each existing dot center of the respective color channels to determine minimum overlap cost values with respect to each existing dot center for each color channel, and an output unit to select one of the existing dots as a new dot center for each of the color channels and to add the new dot centers of each of the color channels to the screen.

The foregoing and/or other aspects of the present general inventive concept may also be achieved by providing an image forming device having the color halftone screen generating system described above.

The foregoing and/or other aspects of the present general inventive concept may also be achieved by providing a computer readable medium containing executable code to generate a color halftone screen in an image forming device, the medium comprising executable code to determine a dot center for each of a plurality of channels arbitrarily, executable code to select a predetermined number of applicants having minimum cost values for each channel by performing a mask operation for each channel, executable code to overlap the determined dot centers of the channels and computing an overlap cost value using an overlap filter, and executable code to output select an applicant closest to a position having a minimum overlap cost value among overlap cost values of the applicants.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 illustrates a conventional amplitude modulated (AM) stochastic screen generating method;

FIG. 2 illustrates a conventional dot order determining method;

FIG. 3 is a flowchart illustrating a color halftone screen generating method in accordance with an embodiment of the present general inventive concept;

FIG. 4A is a graph illustrating a distance function in accordance with an embodiment of the present general inventive concept;

FIG. 4B illustrates an operation of applying the distance function in a cost function in accordance with an embodiment of the present general inventive concept;

FIG. 5A is a diagram illustrating a method of enhancing a uniform distribution of a dot center based on a cost function according to an embodiment of the present general inventive concept;

FIG. 5B is a diagram illustrating an arbitrarily distributed dot center;

FIG. 5C is a diagram illustrating a dot center distributed by performing a smoothing operation on the arbitrarily distributed dot center of FIG. 5B a number of times (e.g., 5);

FIGS. 6(a) to 6(f) illustrate stochastic moiré patterns generated when results binarized with two AM stochastic screens are overlapped;

FIG. 7A is a graph illustrating an overlap frequency filter having a low frequency characteristic in accordance with an embodiment of the present general inventive concept;

FIG. 7B is a graph illustrating an overlap spatial filter obtained by performing frequency inversion on the overlap frequency filter of FIG. 7A;

FIG. 8 illustrates a dot center distribution determining method in the color halftone screen generating method of FIG. 3 in accordance with an embodiment of the present general inventive concept;

FIGS. 9(a) to 9(f) illustrate a comparison between a result of a conventional color halftone screen generating method and a result of a color halftone screen generating method according to embodiments of the present general inventive concept;

FIG. 10A is a graph illustrating a power spectrum when correlation(s) between channels is not considered according to the conventional color halftone screen generating method;

FIG. 10B is a graph illustrating a power spectrum when correlation(s) between channels is considered according to embodiments of the present general inventive concept; and

FIG. 11 illustrates a system to generate a color halftone screen in an image forming device according to an embodiment of the present general inventive concept.

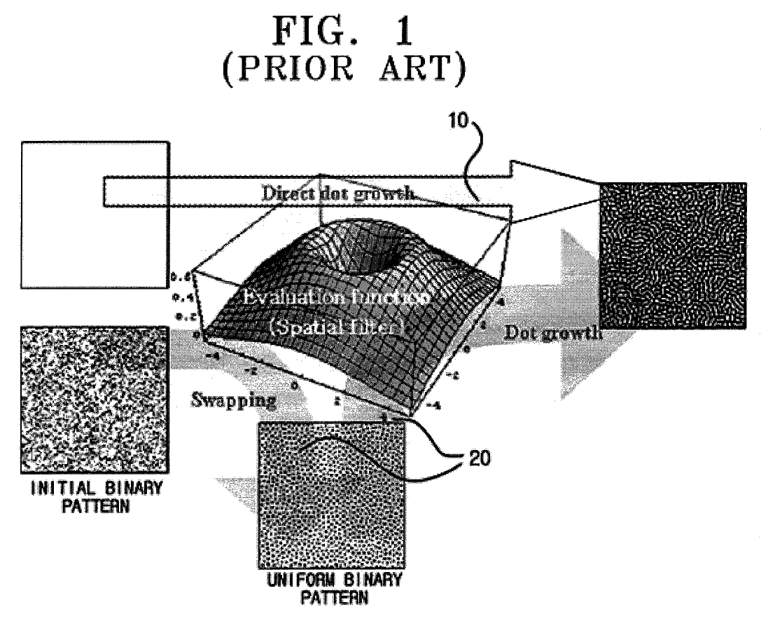

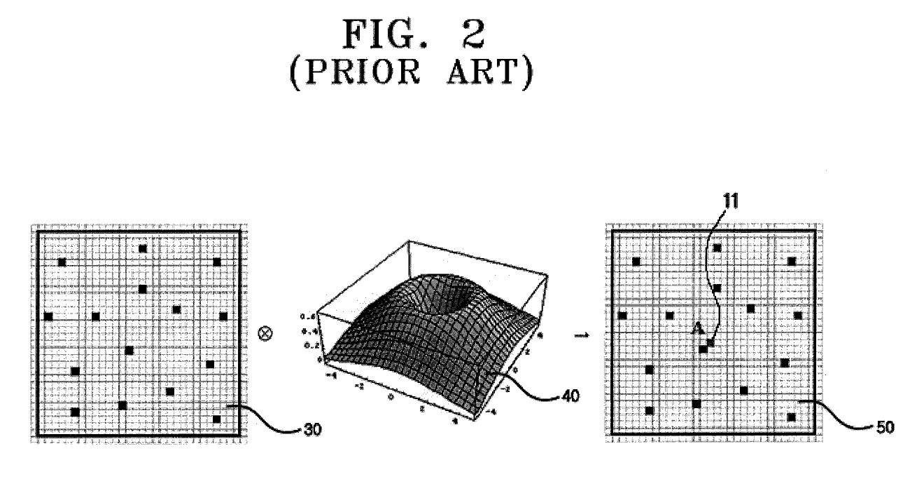

### DETAILED DESCRIPTION OF THE PREFERRED EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

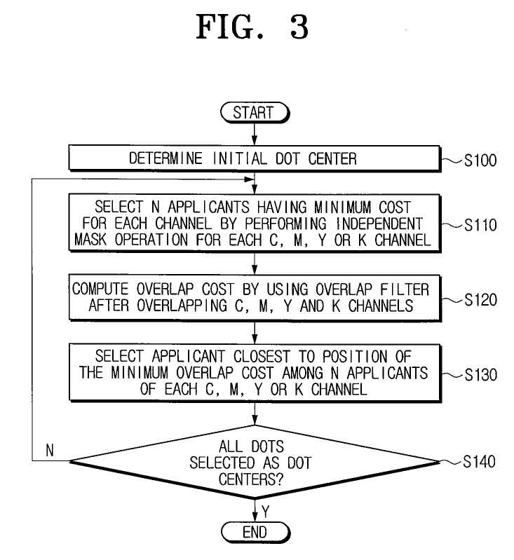

FIG. 3 is a flowchart illustrating a color halftone screen generating method in accordance with an embodiment of the present general inventive concept. The color halftone screen generating method can be used in an AM stochastic screen generating method.

In operation S100, initial dot centers for channels C, M, Y and K are determined arbitrarily.

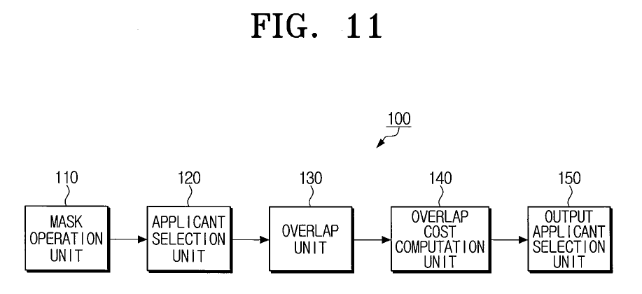

Then, in operation S110, a mask operation unit (see 110 in FIG. 11) performs a mask operation on the determined dot centers according to each of the channels C, M, Y and K independently, and an applicant selection unit (see 120 in FIG. 11) selects a predetermined number of applicants for each channel C, M, Y, and K from a result of the mask operation such that the predetermined number of selected applicants have minimum costs for their respective channels.

An overlap unit (see 130 in FIG. 11) overlaps all the determined dot centers of the channels C, M, Y, and K, and an overlap cost computation unit (see 140 in FIG. 11) computes an overlap cost from an overlap result of the overlapping operation of all the dot centers by using an overlap filter in operation S120.

In operation S130, an output applicant selection unit (see 150 in FIG. 11) selects an applicant closest to a position of a minimum overlap cost value among the overlap costs of the applicants for each of the channels C, M, Y and K.

In operation S140, it is determined whether all the dots of a screen are selected as the dot centers with respect to each channel C, M, Y, and K. If there is a dot that is not determined as a dot center yet, the processes of the operations S110 to S130 are repeated. When all the dots are determined as the dot centers, as described above, a halftoning method can be performed using the dots selected according to the determined respective dot centers (operations of FIG. 3), and the generation of a screen of the present embodiment is complete.

Hereinafter, each operation of the color halftone screen generating method of FIG. 3 will be described in detail. First, most amplitude modulated (AM) stochastic screens generated using spatial filters are different from ordered screens, since the AM stochastic screens do not include a dot center. Similar to the AM ordered screens, the color halftone screen generating method of the present embodiment determines a distribution of an initial dot center and grows dots. The distribution of the initial dot center is a standard point of cluster dots and it affects distribution characteristics of the cluster dots.

According to the color halftone screen generating method of the present embodiment, initial dot centers for the channels C, M, Y, and K are distributed uniformly by the present general inventive concept. They are distributed uniformly without any overlap between the dot centers even when channels C, M, Y, and K are overlapped.

A cost function used to evaluate the extent of the uniform distribution of the dot centers can be defined first. A distance function is used as the cost function to compute effects of one dot center on adjacent dot centers. The distance function may be used in the operation S110 of the method of FIG. 3 with respect to each of the dot centers of the channels.

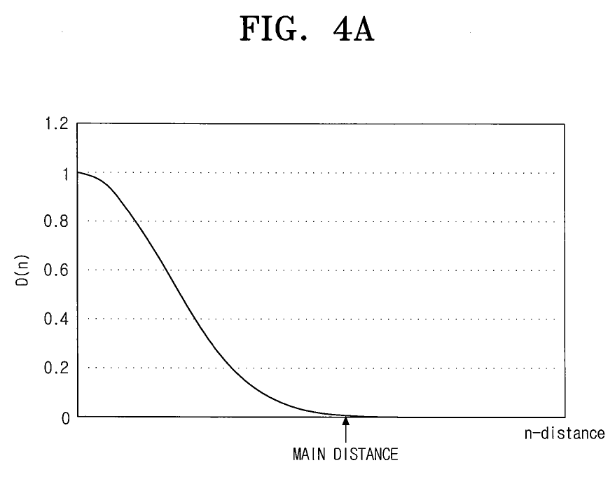

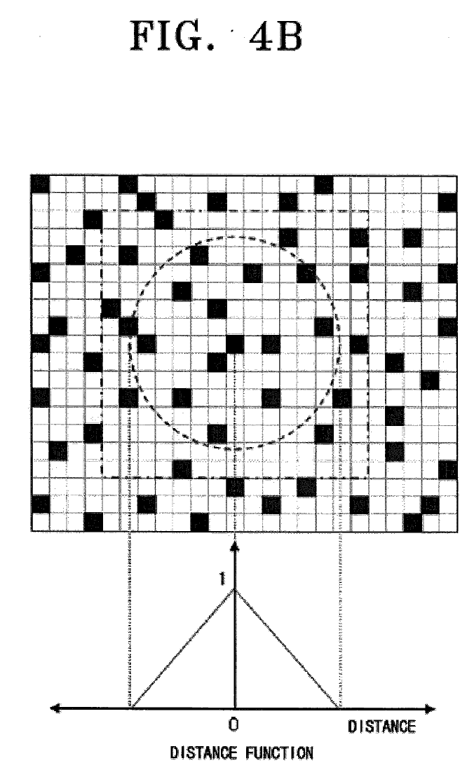

FIG. 4A is a graph illustrating the distance function in accordance with an embodiment of the present general inventive concept. Referring to FIG. 4A, the distance function has a maximum value at a center thereof and values decrease further away from the center.

Thus, the distance function has the maximum value at more than a principal distance, i.e., a desirable distance that should be maintained between the dot centers.

A cost for one dot center can be calculated using the distance function as a weight based on Equation 3:

$$cos t = {\sum }_{i = - n}^{n} {\sum }_{j = - n}^{n} D ( m + i , n + j ) ⊗ DF ( i , j ) \qquad Equation 3$$

where D(m,n) represents a distribution of a dot center and DF(i, j) represents the distance function. Values i and j are in a range of −n to n, and the range is large enough to include the distance function. An operator [symbol] represents a circular multiplication operation for taking ‘tilting’ into consideration when calculating the cost.

FIG. 4B illustrates the operation of applying the distance function as the cost function (the Equation 3) in accordance with an embodiment of the present general inventive concept. A total cost is obtained by applying the Equation 3 to all the dot centers and summating resultant values.

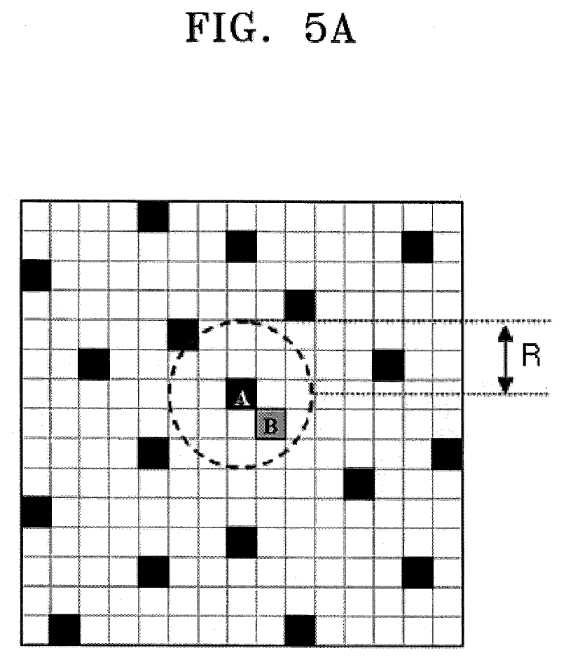

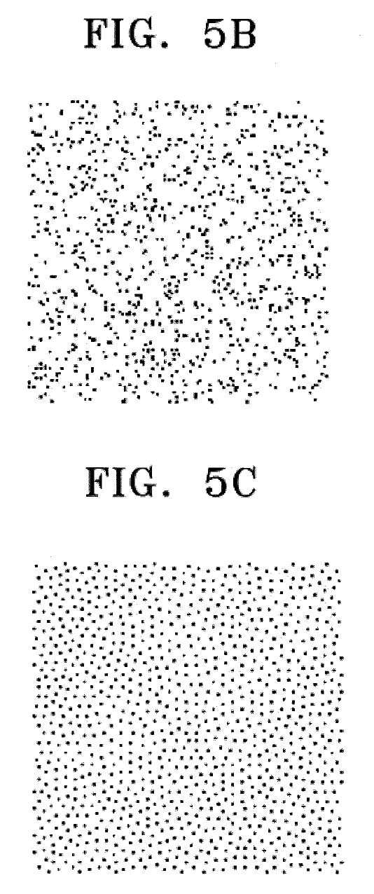

FIG. 5A is a diagram illustrating a method of enhancing the uniform distribution of a dot center based on the cost function defined in the Equation 3. Referring to FIG. 5A, a dot center determination unit (not shown) increases the extent of the uniform distribution of the dot center by performing a smoothing operation. According to the smoothing operation, an applicant range (R) is determined based on one dot center, and a position A at a center of the applicant range (R) and a position B where the cost is the least (at the minimum value) are found. The positions A and B are swapped with each other in a swapping operation. Thus, the dot center is changed from the position A to the position B.

When the smoothing operation is performed about five to seven times with respect to all the dot centers, uniformly distributed dot centers can be obtained. FIG. 5B is a diagram illustrating an arbitrarily distributed dot center, and FIG. 5C is a diagram illustrating a dot center distributed by performing the smoothing operation on the arbitrarily distributed dot center FIG. 5B about five times.

The smoothing operation can be applied to the color channels according to the method of FIG. 3 and the other embodiments of the present general inventive concept. In order to apply the above-described smoothing operation to a color channel, the following factors may be considered.

1) The human eye recognizes a yellow channel (Y) more dully than other color channels. For example, when a pattern of cyan (C) and yellow channels (Y) is mixed and distributed, the extent of a uniform distribution of the cyan channel (C) dominates the performance of a mixed color pattern. Therefore, the dot center of the yellow channel (Y) is distributed uniformly in the present embodiment, regardless of the other channel(s).

2) Generally, since laser printing devices do not use much black ink in a highlight range, the uniform distribution of cyan (C) and magenta channels (M) becomes more important.

Except the yellow channel (Y), when dots of cyan (C), magenta (M), and black (K) channels are uniformly distributed without overlapping each other, the dots of each color channel C, M, and K are all distributed uniformly such that the dot centers also show a uniform distribution when all the three color channels C, M, and K are overlapped. However, when the cyan (C) and magenta (M) channels are overlapped, a non-uniform and unpleasant pattern appears.

Accordingly, it may be desirable to determine the dot center distribution of the cyan (C) and magenta (M) channels before determining the dot center distribution of the black channel (K).

The Equation 3 (above) evaluates the uniform distribution of a dot center of a single channel (i.e., one color). Thus, in order to avoid overlap in the dot centers when multiple color channels are overlapped, the Equation 3 should be modified as Equation 4:

$$cos t = {\sum }_{i = - n}^{n} {\sum }_{j = - n}^{n} ( \begin{matrix}α \times D ( m + i , n + j ) ⊗ \\ {DF}_{ M} ( i , j ) + ( 1 - α ) \times \\ S ( m + i , n + j ) ⊗ {DF}_{ C} ( i , j )\end{matrix} ) \qquad Equation 4$$

where D(m,n) represents a dot center of a single channel, S(m,n) represents a dot center where all color channels are overlapped, DF_{M} and DF_{c} are distance functions for a single channel and a color channel, respectively, and α is a weight to adjust the extent of uniform distribution between the single channel and the overlapped channels.

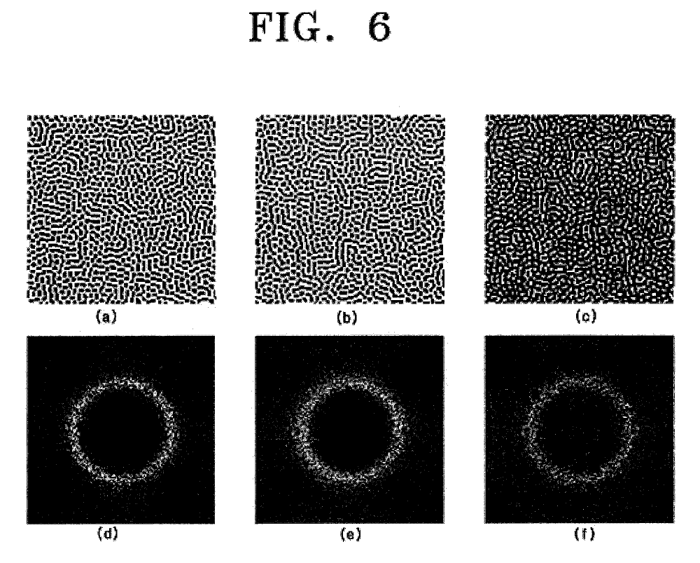

FIGS. 6(a) to 6(f) illustrate stochastic moiré patterns generated when results binarized with two AM stochastic screens are overlapped. FIGS. 6(d) to 6(f) illustrate stochastic moiré patterns obtained by performing frequency conversion on FIGS. 6(a) to 6(c). FIG. 6(c) is obtained by overlapping images of the two AM stochastic screens of FIGS. 6(a) and 6(b).

Referring to FIG. 6(f), it can be seen that a low frequency component which is not generated in a low frequency area of FIGS. 6(d) and 6(e) is generated in FIG. 6(f). A resulting pattern that is generated due to the low frequency component generated on the low frequency area of FIG. 6(f) is called a “stochastic moiré pattern.”

The generation of the stochastic moiré pattern can be described in a frequency area. Since the overlapping of FIGS. 6(a) and 6(b) appears in the form of a convolution of FIGS. 6(d) and 6(e) in the frequency area, the low frequency component is always generated when the two binarized images are overlapped.

The color halftone screen generating method of the present embodiment considers correlation(s) between channels to remove the low frequency component. The stochastic moiré pattern is generated when a screen is generated independently without considering the correlation(s) between the channels.

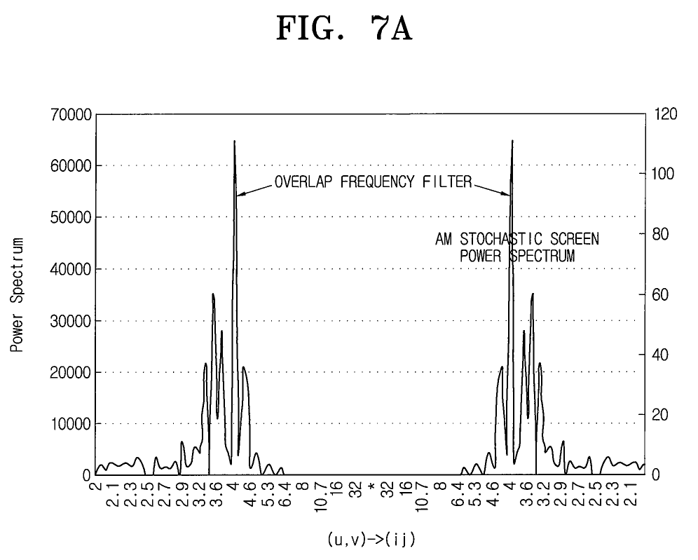

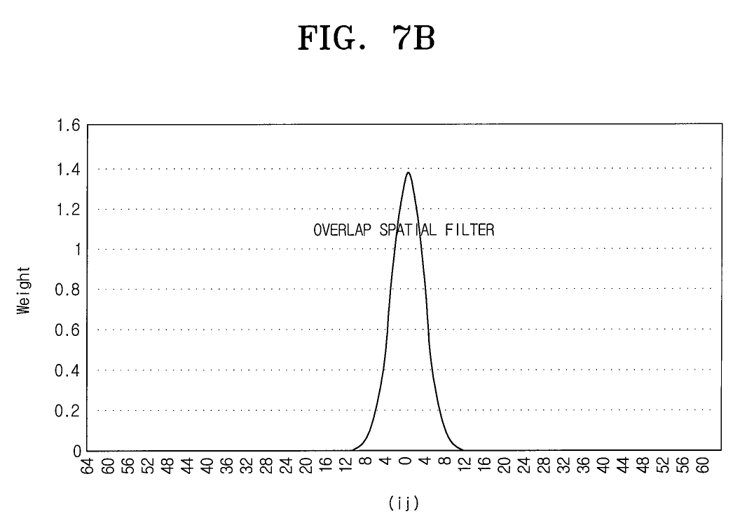

FIG. 7A is a graph illustrating an overlap frequency filter having a low frequency characteristic in accordance with an embodiment of the present general inventive concept. The color halftone screen generating method of the present embodiment reduces uses a new overlap filter having a low frequency characteristic, such as the overlap frequency filter illustrated in FIG. 7A, to reduce the low frequency components corresponding to FIGS. 6(a) to 6(f).

The overlap frequency filter having the low frequency characteristic makes the distribution of cluster dots to have a high frequency characteristic, which is already illustrated when the mask operation is described with respect to physical operation. FIG. 7A illustrates the overlap frequency filter (Filters(u,v)) used in the present embodiment and a power spectrum of a single channel. Herein, the Filters(u,v) is defined as the overlap frequency filter.

The overlap frequency filter is a Gaussian function, and the overlap frequency filter is applied to an area having a frequency that is less than a frequency that represents a cluster dot main distance in a single channel. This is because the low frequency component of a color channel is generated in an area smaller than the frequency representing the cluster dot main distance. A dot center is a center of adjacent dots. Cluster dots are dots disposed around the dot center to be processed to produce a halftone. The processed cluster dots are represented to compensate for the gray level. The cluster dot main distance refers to a distance between cluster dots.

FIG. 7B is a graph illustrating an overlap spatial filter obtained by performing frequency inversion on the overlap frequency filter (Filters(u,v)) of FIG. 7A. Referring to FIG. 7B, Filters(i,j) which is generated by performing the inverse frequency conversion on the overlap frequency filter (Filters (u, v)) is defined as the overlap spatial filter. The overlap spatial filter (Filters(i,j)) of FIG. 7B is used for the generation of a screen by considering the correlation(s) between channels, which is different from an independent screen generation. Thus, the low frequency components illustrated in FIGS. 6(a) to 6(f) can be reduced when dots centers are calculated using filters of FIGS. 7A and 7B.

FIG. 8 illustrates a dot center distribution determining method in the color halftone screen generating method in accordance with an embodiment of the present general inventive concept. The color halftone screen generating method of the present general inventive concept establishes “n” applicant dots to apply the overlap spatial filter. Hereinafter, the color halftone screen generating method will be described with reference to FIG. 8 by assuming that four applicant dots are used (i.e., “n”=4).

Herein, each of the channel initial dot centers uses the dot center distribution determined in the dot center distribution determining method, and the overlap frequency filter (Filters(u,v)) used for the generation of a single channel screen is used. The graph of FIG. 7B is used as the overlap spatial filter (Filters(i,j)) in mask operations performed on the overlapped dot centers described below.

(a) A mask operation is performed by using the overlap spatial filter (Filters(i,j)) independently with respect to the channels C, M, Y and K, and four applicant dots having a minimum overlap cost value are selected with respect to each channel (i.e., a total of 16 applicant dots).

(b) The dots of the channels C, M, Y and K are overlapped based on a luminance value. The mask operation is performed on the overlapped luminance values by using the overlap spatial filter (Filters(i,j)) and a position having the minimum overlap cost value with respect to an initial black dot center(s) is detected from the mask operation result.

(c) An applicant dot closest to the position having the minimum overlap cost value detected in operation (b) from among the four dot applicants of the black channel K is determined as an order of the black channel K. In other words, the closest applicant dot is determined to be used as a new dot center of the black channel K.

(d) With the dots of the black channel K added to a screen, the mask operation is performed by using the overlap spatial filter, and a position having the minimum overlap cost value with respect to an initial magenta dot center(s) is detected.

(e) An applicant dot closest to the position having the minimum overlap cost value detected in operation (d) from among the four dot applicants of the magenta channel M is determined as an order of the magenta channel M. In other words, the closest applicant dot is determined to be used as a new dot center of the magenta channel M.

(f) With the dots of the magenta channel M added to the dots of the black channel K on the screen, the mask operation is performed by using the overlap spatial filter, and a position having the minimum overlap cost value with respect to an initial cyan dot center(s) is detected.

(g) An applicant dot closest to the position having the minimum overlap cost value detected in operation (f) among the four dot applicants of the cyan channel C is determined as an order of the cyan channel C. In other words, the closest applicant dot is determined to be used as a new dot center of the cyan channel C.

(h) With the dots of the cyan channel C added to the dots of the black channel K and the dots of the magenta channel M on the screen, the mask operation is performed by using the overlap spatial filter, and a position having the minimum overlap cost value with respect to an initial yellow dot center(s) is detected.

(i) An applicant dot closest to the position having the minimum overlap cost value detected in operation (h) among the four dot applicants of the yellow channel Y is determined as an order of the yellow channel Y. In other words, the closest applicant dot is determined to be used as a new dot center of the yellow channel Y.

The above-described operations (a) to (i) are repeated until the order of each channel C, M, Y, and K becomes the same as a size of the screen. In short, the operations (a) to (i) are repeated until all the dots of the screen are selected as dot centers with respect to the channels C, M, Y and K.

The overlap mask operation of FIG. 8 is a mask operation using the overlap spatial filter. The color halftone screen generating method of the present embodiment uses the luminance values to give a different weight to the overlap spatial filter for each channel. This is because the recognition extent of the stochastic moiré pattern generated due to channel overlapping is different according to each channel. In the present embodiment, the luminance values of the channels may be K=1, M=0.5, C=0.4, and Y=0.1.

Although there is little difference between the above-determined values and actual luminance rates of the channels C, M, Y and K, values similar to the actual luminance rates may be determined for generation of the color halftone screen to satisfy K=C+M+Y, a condition which indicates that a weight applied to black dots should be the same as a weight of cyan, magenta and yellow dots overlapped.

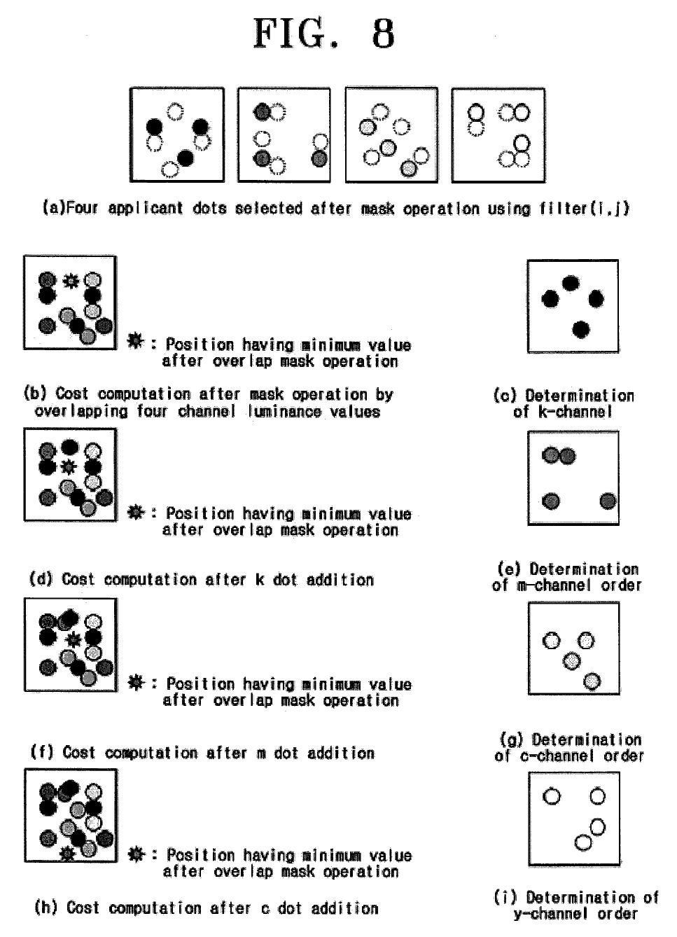

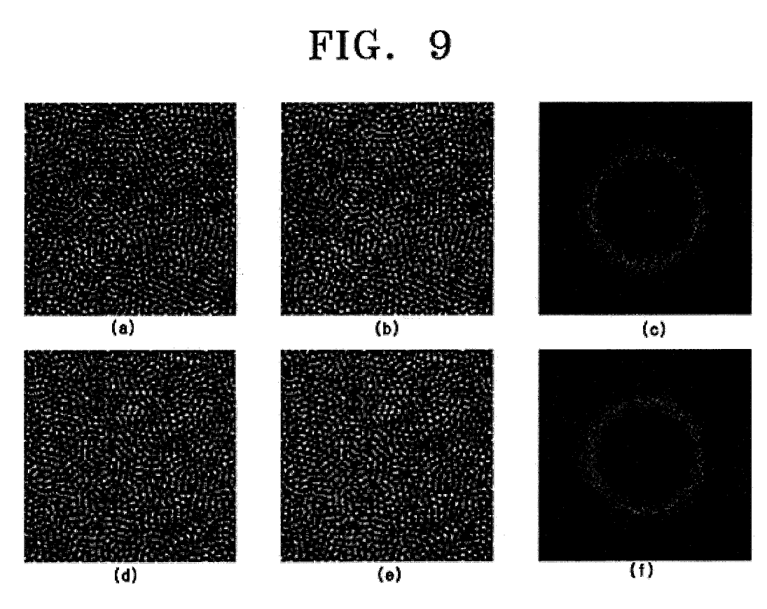

FIGS. 9(a) to 9(f) illustrate a comparison between a result of a conventional color halftone screen generating method and a result of the color halftone screen generating method according the embodiments of the present general inventive concept.

FIGS. 9(a) and 9(d) respectively illustrate resultant images obtained by binarizing a uniform gray-level image when correlation(s) between channels is not considered according to a conventional method, and when the correlation(s) between channels is considered according to the method of the embodiments of the present general inventive concept.

FIGS. 9(b) and 9(e) respectively illustrate resultant images obtained by overlapping luminance values when the correlation(s) between channels is not considered according to the conventional method, and when the correlation(s) between channels is considered according to the embodiments of the present general inventive concept.

FIGS. 9(c) and 9(f) respectively illustrate power spectra obtained when the correlation(s) between channels is not considered according to the conventional method, and when the correlation(s) between channels is considered according to the embodiments of the present general inventive concept. The power spectrum of FIG. 9(f) illustrates that much of the low frequency component is removed, compared to that of FIG. 9(c).

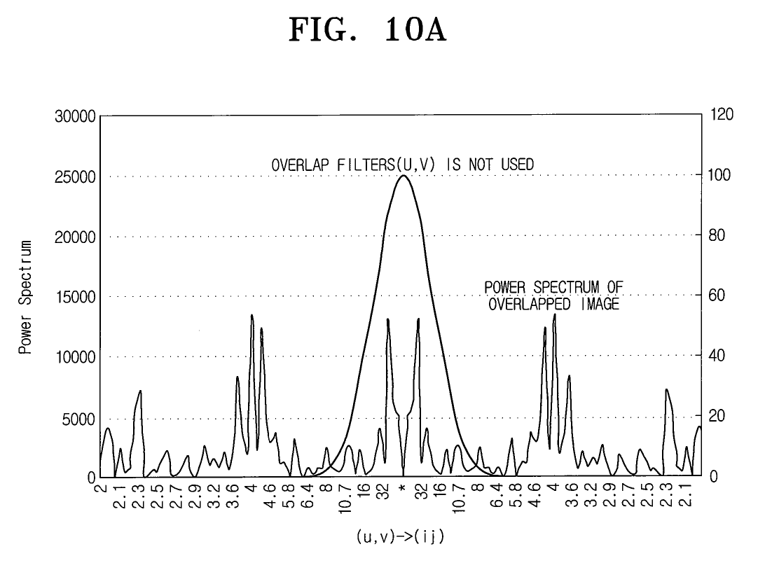

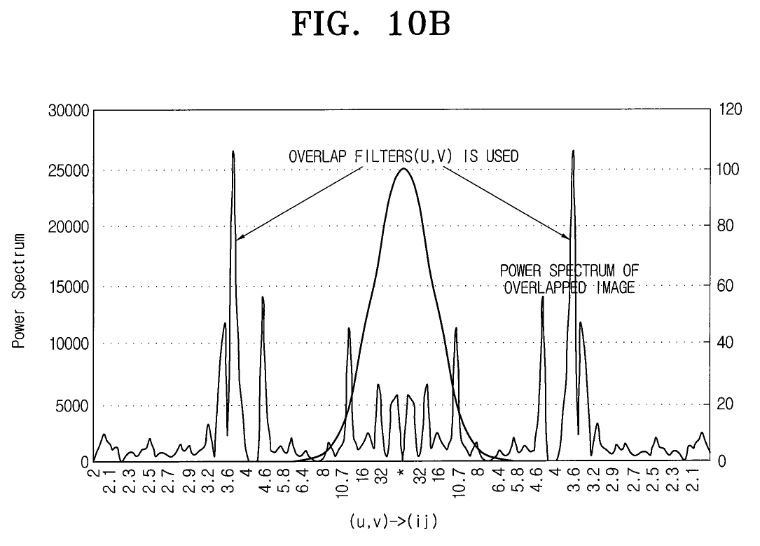

FIG. 10A is a graph illustrating a power spectrum when the correlation(s) between channels is not considered according to the conventional method. FIG. 10B is a graph illustrating a power spectrum when the correlation(s) between channels is considered according to the embodiments of the present general inventive concept. Referring to FIG. 10B, it can seen that the low frequency component is decreased and the frequency component of cluster dot main distance is increased.

Generally, as a frequency component of a predetermined pattern is larger and close to an origin point, the human eye recognizes more, which is a Contrast Sensitivity Function (CSF). In short, the human eye is better at detecting a large frequency component close to the origin point of FIG. 10A. Also, the large frequency component of the cluster dot main distance in FIG. 10B signifies that the overlapped screen has AM stochastic characteristics.

FIG. 11 illustrates a system 100 to generate a color halftone screen in an image forming device according to an embodiment of the present general inventive concept. The system 100 includes a mask operation unit 110, an applicant selection unit 120, an overlap unit 130, and an overlap cost computation unit 140, and an output applicant selection unit 150. The system 100 may perform the method of FIG. 3. More generally, the mask operation unit 110 performs a mask operation with respect to each of a plurality of channels from a dot center arbitrarily determined for each channel, the applicant selection unit 120 selects a predetermined number of applicants having minimum cost values with respect to each channel based on a result of the mask operation, the overlap unit 130 overlaps the determined dot centers of the channels to produce an overlap result, the overlap cost computation unit 140 computes an overlap cost value using an overlap filter based on the overlap result, and the output applicant selection unit 150 selects an applicant closest to a position having a minimum overlap cost value from among overlap costs of the applicants.

The present general inventive concept can be embodied as computer-readable code/instructions/programs and can be implemented in general-use digital computers that execute the code/instructions/programs using a computer-readable recording medium. Examples of the computer-readable recording medium include magnetic storage media (e.g., ROM, floppy disks, hard disks, etc.), optical recording media (e.g., CD-ROMs, or DVDs), and storage media such as carrier waves (e.g., transmission through the internet). Further, the present general inventive concept can be embodied as a computer-readable recording medium having computer-readable code, and the computer-readable recording medium can also be distributed over network-coupled computer systems so that the computer-readable code is stored and executed in a distributed fashion. Also, functional programs, code, and code segments for accomplishing the present general inventive concept can be easily construed by programmers skilled in the art to which the present general inventive concept pertains.

As described above, the embodiments of the present general inventive concept reduce a pattern of low frequency characteristics generated due to overlapping of color channels, and improve a quality of a binary output image by uniformly distributing overlapped cluster dots.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A method of generating a color halftone screen in an image forming device, the method comprising:
determining a dot center for each of a plurality of channels arbitrarily;
selecting a predetermined number of applicants having minimum cost values for each channel by performing a mask operation for each channel;
overlapping the determined dot centers of the channels and computing an overlap cost value using an overlap filter; and
output selecting an applicant closest to a position having a minimum overlap cost value among overlap cost values from among the applicants.

2. The method as recited in claim 1, wherein the mask operation is performed independently using a spatial filter with respect to each channel.

3. The method as recited in claim 1, wherein the predetermined number of applicants comprises four applicant dots.

4. The method as recited in claim 1, wherein the overlapping of the determined dot centers of the channels comprises overlapping luminance values of the channels.

5. The method as recited in claim 1, wherein the channels include a cyan channel C, a magenta channel M, a yellow channel Y, and a black channel K.

6. The method as recited in claim 1, wherein the output selected applicant is determined as the dot center of the corresponding channel, and the overlapping and output selecting operations are repeated for the other channels.

7. The method as recited in claim 6, wherein the overlapping and output selecting operations are performed repeatedly until all dots of a screen are selected as the dot center with respect to each channel.

8. The method as recited in claim 1, wherein the overlapping and the output selecting operations are repeated for each of the channels to select new dot centers that do not overlap with one another even though the channels overlap.

9. The method as recited in claim 1, wherein the selecting of the predetermined number of applicants having minimum cost values is performed according
$$cos t = {\sum }_{i = - n}^{n} {\sum }_{j = - n}^{n} D ( m + i , n + j ) ⊗ DF ( i , j )$$
where D(m,n) represents a distribution of a dot center, DF(i, j) represents a distance function, values i and j are in a range of −n to n including the distance function, and operator [symbol] represents a circular multiplication operation.

10. The method as recited in claim 1, wherein the output selected applicant is determined as a new dot center.

11. The method as recited in claim 10, wherein the dot centers of the plurality of channels are added together to form a screen.

12. The method as recited in claim 1, wherein the overlapping of the dot centers comprises computing the overlap cost values according to:
$$cos t = {\sum }_{i = - n}^{n} {\sum }_{j = - n}^{n} ( \begin{matrix}α \times D ( m + i , n + j ) ⊗ \\ {DF}_{ M} ( i , j ) + ( 1 - α ) \times \\ S ( m + i , n + j ) ⊗ {DF}_{ C} ( i , j )\end{matrix} )$$
where D(m,n) represents a dot center of a single channel, S(m,n) represents a dot center where all color channels are overlapped, DF_{M} and DF_{c} are distance functions for a single channel and a color channel, respectively, α is a weight to adjust an extent of a uniform distribution between the single channel and the overlapped channels, values i and j are in a range of −n to n including the distance functions, and an operator [symbol] represents a circular multiplication operation.

13. The method as recited in claim 1, wherein the overlapping and the output selecting operations comprise performing a smoothing operation to enhance a uniform distribution of the output selected applicants as new dot centers.

14. A method of determining dots for a plurality of color channels on a screen, the method comprising:
selecting a predetermined number of applicant dots associated with initial dot centers for the plurality of color channels;
applying an overlap spatial filter to each of the initial dot centers to account for correlations between the color channels and to determine an applicant dot having a minimum cost overlap value with respect to the initial dot centers of each of the color channels; and
setting the applicant dots having the minimum cost overlap values with respect to the initial dot centers as new dot centers.

15. A system to generate a color halftone screen in an image forming device, comprising:
a mask operation unit to perform a mask operation with respect to each of a plurality of channels from a dot center arbitrarily determined for each channel;
an applicant selection unit to select a predetermined number of applicants having minimum cost values with respect to each channel based on a result of the mask operation;
an overlap unit to overlap the determined dot centers of the channels to produce an overlap result;
an overlap cost computation unit to compute an overlap cost value using an overlap filter based on the overlap result; and
an output applicant selection unit to select an applicant closest to a position having a minimum overlap cost value among overlap cost values from among the applicants.

16. The system as recited in claim 15, wherein the mask operation unit performs the mask operation independently by using a spatial filter with respect to each channel.

17. The system as recited in claim 15, wherein the applicant selection unit selects four applicant dots for each channel.

18. The system as recited in claim 15, wherein the overlap unit overlaps the determined dot centers by overlapping luminance values of the channels.

19. The system as recited in claim 15, wherein the channels include a cyan channel C, a magenta channel M, a yellow channel Y, and a black channel K.

20. The system as recited in claim 15, wherein the output applicant selection unit determines the selected applicant as a dot center of the corresponding channel.

21. A system to generate a color halftone screen having a plurality of color channels in an image forming device, the system comprising:
an applicant selection unit to apply a first cost function individually to each existing dot center of the respective color channels on a screen to select a predetermined number of existing dots having minimum cost values with respect to each existing dot center for each color channel;
an overlapping unit to overlap the existing dot centers of the respective color channels and to apply a second cost function to each existing dot center of the respective color channels to determine minimum overlap cost values with respect to each existing dot center for each color channel; and
an output unit to select one of the existing dots as a new dot center for each of the color channels and to add the new dot centers of each of the color channels to the screen.

22. The system as recited in claim 21, wherein the applicant selection unit applies the first cost function by applying a spatial mask associated with a distance function to each of the existing dot centers of the respective color channels.

23. The system as recited in claim 21, wherein the applicant selection unit, the overlapping unit, and the output unit operate until all existing dots in the screen are made dot centers for one of the color channels.

24. An image forming device having a color halftone screen generating system, comprising:
a mask operation unit to perform a mask operation with respect to each of a plurality of channels from a dot center arbitrarily determined for each channel;
an applicant selection unit to select a predetermined number of applicants having minimum cost values with respect to each channel based on a result of the mask operation;
an overlap unit to overlap the determined dot centers of the channels to produce an overlap result;
an overlap cost computation unit to compute an overlap cost value using an overlap filter based on the overlap result; and
an output applicant selection unit to select an applicant closest to a position having a minimum overlap cost value among overlap cost values from among the applicants.

25. A computer readable medium containing executable code to generate a color halftone screen in an image forming device, the medium comprising:
executable code to determine a dot center for each of a plurality of channels arbitrarily;
executable code to select a predetermined number of applicants having minimum cost values for each channel by performing a mask operation for each channel;
executable code to overlap the determined dot centers of the channels and computing an overlap cost value using an overlap filter; and
executable code to output select an applicant closest to a position having a minimum overlap cost value among overlap cost values from among the applicants.
